(19) United States
(12) Patent Application Publication
(10) Pub. No.: US 2014/0063380 A1
(43) Pub. Date: Mar. 6, 2014

(54) DISPLAY APPARATUS AND METHOD OF DRIVING THE SAME

(71) Applicant: SAMSUNG DISPLAY CO., LTD., Yongin-City (KR)

(72) Inventors: Hyun-Sik YOON, Asan-si (KR); JUNPYO LEE, Asan-si (KR); Jaehyun KOH, Seoul (KR); Youngrok NOH, Ansan-si (KR)

(73) Assignee: SAMSUNG DISPLAY CO., LTD., Yongin-City (KR)

(21) Appl. No.: 13/738,531

(22) Filed: Jan. 10, 2013

(30) Foreign Application Priority Data
Aug. 29, 2012 (KR) 10-2012-0095085

(51) Int. Cl. G02B 27/22

(52) U.S. Cl. CPC G02B 27/2264
USPC 349/15

(57) ABSTRACT

A display apparatus includes a display panel which includes a plurality of pixels, a backlight unit which includes a plurality of light sources sequentially arranged in a first direction of the display panel and provides light to the display panel, and a driving circuit which controls the display panel to allow an image to be displayed on the display panel and generates a plurality of backlight control signals to periodically turn on and off the light sources. The driving circuit generates the backlight control signals to allow the light sources to have different turn-on time periods based on positions of the light sources.

This application claims priority to Korean Patent Application No. 10-2012-0095085, filed on Aug. 29, 2012, and all the benefits accruing therefrom under 35 U.S.C. §119, the content of which in its entirety is hereby incorporated by reference.

### BACKGROUND

1. Field

The disclosure relates to a display apparatus and a method of driving the display apparatus.

2. Description of the Related Art

In general, a display apparatus displays a two-dimensional image. In recent years, demand for a three-dimensional (“3D”) image display apparatus keeps on increasing in various fields, such as movie, medical image processing, game, advertisement, education, etc., and thus the 3D image display apparatus that displays a 3D image has been researched.

The 3D image display apparatus provides the 3D image by using binocular disparity between the human eyes. Since the human eyes are spaced apart and separated from each other by the nose, images observed at different angles by two eyes of a viewer are transmitted to the human brain. The human brain mixes the images with each other and perceives the 3D image.

The 3D image display apparatus is typically classified into two types, e.g., a stereoscopic 3D display and an auto-stereoscopic 3D display according to whether the viewer wears special glasses. As the auto-stereoscopic 3D display, a lenticular method and a parallax barrier method have been suggested. In addition, a polarization method and a shutter glass method have been developed for the stereoscopic 3D display.

Particularly, the shutter glass method alternately opens a left-eye shutter and a right-eye shutter of shutter glasses in synchronization with a display period of a left-eye image and a right-eye image. In a case that a liquid crystal display is used as the 3D image display apparatus, a left-eye image displayed during a left-eye frame may exert influence on a right-eye image displayed during a right-eye frame, or vice versa due to slow response speed of liquid crystals, thereby causing deterioration in image display quality. Accordingly, a display method that periodically turns on and off a backlight unit has been suggested.

### SUMMARY

The disclosure provides a display apparatus in which crosstalk is effectively prevented.

The disclosure provides a method of driving the display apparatus, which effectively prevents the crosstalk of the display apparatus.

An exemplary embodiment of the invention provides a display apparatus including a display panel which includes a plurality of pixels, a backlight unit which includes a plurality of light sources sequentially arranged in a first direction of the display panel to provide a light to the display panel, and a driving circuit which controls the display panel to allow an image to be displayed on the display panel and generates a plurality of backlight control signals to periodically turn on and off the light sources, where the driving circuit generates the backlight control signals to allow the light sources to have different turn-on time periods based on positions of the light sources.

In an exemplary embodiment, the turn-on time period of the light sources disposed closer to a center portion in the first direction of the display panel may be shorter than the turn-on time period of the light sources disposed at a side portion in the first direction of the display panel.

In an exemplary embodiment, the pixels may be connected to a plurality of gate lines and a plurality of data lines crossing the gate lines, and the driving circuit may include a data driver which drives the data lines, a gate driver which drives the gate lines, and a timing controller which controls the data driver and the gate driver in response to an image signal and a control signal from an external source and generates the backlight control signals.

In an exemplary embodiment, the timing controller may include a driving controller which controls the data driver and the gate driver in response to the image signal and the control signal and a backlight controller which generates the backlight control signals.

In an exemplary embodiment, the driving controller may apply a vertical synchronization start signal and an output enable signal, which are generated from the timing controller based on the control signal, to the gate driver.

In an exemplary embodiment, the backlight controller may generate the backlight control signals in response to the vertical synchronization start signal and the output enable signal.

In an exemplary embodiment, the backlight controller may include a counter which outputs a count signal in response to the vertical synchronization start signal and the output enable signal and a backlight control signal generator which outputs the backlight control signals in response to the count signal from the counter.

In an exemplary embodiment, the counter may start counting in response to the vertical synchronization start signal and increases the count signal in synchronization with the output enable signal.

In an exemplary embodiment, the backlight control signal generator may include a register which stores a plurality of first count signals respectively corresponding to turn-on time points of the light sources and a plurality of second count signals respectively corresponding to turn-off time points of the light sources.

In an exemplary embodiment, the backlight control signal generator may transit a corresponding backlight control signal of the backlight control signals to a first level when the count signal from the counter reaches each of the first count signals, and the backlight control signal generator may transit the corresponding backlight control signal of the backlight control signals to a second level when the count signal from the counter reaches each of the second count signals.

In an exemplary embodiment, the register may further store a plurality of third count signals, each corresponding to an initialization time point of a corresponding light source of the light sources, and the backlight control signal generator may transit the backlight control signals to the first level when the count signal from the counter reaches a sum of corresponding first and third count signals among the first count signals and the third count signals while the display apparatus is reset.

In an exemplary embodiment, the pixels may be connected to a plurality of gate lines and a plurality of data lines crossing the gate lines, and the driving circuit may include a data driver which drives the data lines, a gate driver which drives the gate lines, a timing controller which controls the data driver in response to an image signal and a control signal from an external source and applies the backlight control signals to the gate driver, and a backlight controller which generates the backlight control signals.

In an exemplary embodiment, the backlight controller may include a counter which outputs a count signal in response to a vertical synchronization start signal and an output enable signal, which are generated from the timing controller based on the control signal, and a backlight control signal generator which outputs the backlight control signals in response to the count signal from the counter.

In an exemplary embodiment, the counter may start counting in response to the vertical synchronization start signal and increase the count signal in synchronization with the output enable signal, and the backlight control signal generator may include a register which stores a plurality of first count signals respectively corresponding to turn-on time points of the light sources and a plurality of second count signals respectively corresponding to turn-off time points of the light sources.

In an exemplary embodiment, the backlight control signal generator may transit a corresponding backlight control signal of the backlight control signals to a first level when the count signal from the counter reaches each of the first count signals, and the backlight control signal generator may transit the corresponding backlight control signal of the backlight control signals to a second level when the count signal from the counter reaches each of the second count signals.

An exemplary embodiment of the invention provides a method of driving a display apparatus counting a second signal in response to a first signal to output a count signal; transiting a corresponding backlight control signal to a first level when the count signal reaches each of a plurality of first count signals respectively corresponding to turn-on time points of a plurality of light sources of the display apparatus; and transiting the corresponding backlight control signal to a second level when the count signal reaches each of a plurality of second count signals respectively corresponding to turn-off time points of the light sources, where the light sources are sequentially arranged in a first direction of a display panel of the display apparatus, and the first count signals and second count signals are set based on positions of the light sources arranged in the first direction.

In an exemplary embodiment, the first and second count signals may be set to allow a turn-on time period of the light sources disposed closer to a center portion in the first direction of the display panel to be shorter than a turn-on time period of the light sources respectively disposed at a side portion in the first direction of the display panel.

In an exemplary embodiment, the first signal may be a vertical synchronization start signal, and the second signal may be an output enable signal.

According to one or more exemplary embodiment, the display apparatus periodically turns on and off the backlight unit and the light sources included in the backlight unit are turned on during different time periods such that a crosstalk is effectively prevented.

### BRIEF DESCRIPTION OF THE DRAWINGS

The above and other features of the invention will become readily apparent by reference to the following detailed description when considered in conjunction with the accompanying drawings, in which:

FIG. 1 is an exploded perspective view of an exemplary embodiment of a display apparatus according to the invention;

FIG. 2 is a block diagram showing an exemplary embodiment of the display apparatus including a display panel, a driving circuit and a backlight unit shown in FIG. 1;

FIG. 3 is a block diagram showing an exemplary embodiment of the backlight unit shown in FIG. 2;

FIG. 4 is a block diagram showing an exemplary embodiment of a timing controller shown in FIG. 2;

FIG. 5 is a block diagram showing an exemplary embodiment of a backlight controller shown in FIG. 4;

FIG. 6 is a signal timing diagram showing an operation of the display apparatus shown in FIGS. 1 to 5;

FIG. 7 is a signal timing diagram showing another operation of the display apparatus shown in FIGS. 1 to 5;

FIG. 8 is a signal timing diagram showing an operation of the display apparatus shown in FIGS. 1 to 5 when the display apparatus is reset;

FIG. 9 is a flowchart showing an exemplary embodiment of an operation of a backlight control signal generator shown in FIG. 5;

FIGS. 10 and 11 are signal timing diagrams showing backlight control signals when the number of light sources included in the backlight unit is six;

FIGS. 12 and 13 are signal timing diagrams showing backlight control signals when the number of light sources included in the backlight unit is eight; and

FIG. 14 is a block diagram showing an alternative exemplary embodiment of a display apparatus according to the invention.

### DETAILED DESCRIPTION

The invention will be described more fully hereinafter with reference to the accompanying drawings, in which various embodiments are shown. This invention may, however, be embodied in many different forms, and should not be construed as limited to the embodiments set forth herein. Rather, these embodiments are provided so that this disclosure will be thorough and complete, and will fully convey the scope of the invention to those skilled in the art. Like reference numerals refer to like elements throughout.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms, “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims set forth herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein. Hereinafter, exemplary embodiments of the invention will be described in detail with reference to the accompanying drawings.

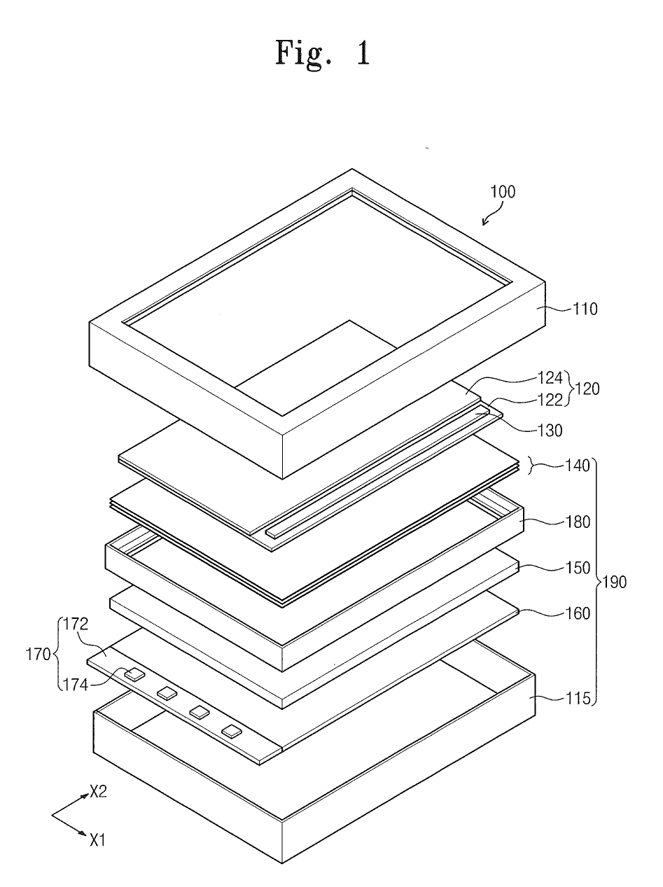

FIG. 1 is an exploded perspective view of an exemplary embodiment of a display apparatus according to the invention.

Referring to FIG. 1, a display apparatus 100 includes an upper receiving container 110, a display panel 120 and a backlight assembly 190. The backlight assembly 190 includes an optical sheet 140, a mold frame 180, a light guide plate 150, a backlight unit 170, a reflection sheet 160 and a lower receiving container 115.

The display panel 120 includes a lower display substrate 122 including gate lines, data lines, and thin film transistors and pixel electrodes and an upper display substrate 124 including a black matrix and a common electrode and disposed opposite to the lower display substrate 122. In an alternative exemplary embodiment, the black matrix and the common electrode may be disposed on the lower display substrate 122. The display panel 120 receives light from the backlight unit 170 and displays images. In an alternative exemplary embodiment, polarization films may be disposed on upper and lower surfaces of the display panel 120, respectively. In the exemplary embodiment, a size of the upper display substrate 124 may be less than a size of the lower display substrate 122. A driving circuit 130 includes a plurality of integrated circuit chips and is disposed, e.g., mounted, on an edge of the lower display substrate 122, which is overlaps the upper display substrate 124.

When the thin film transistors are turned on, an electric field is generated between the common electrode and the pixel electrode. In such an embodiment, liquid crystal molecules of a liquid crystal layer disposed between the lower display substrate 122 and the upper display substrate 124 are rearranged due to the electric filed, and thus a light transmittance is changed in each pixel of the display panel 120. As described above, the display panel 120 controls the transmittance of the light passing therethrough, thereby displaying predetermined images.

The upper receiving container 110 is provided with a window formed therethrough to expose the display panel 120 and provides a space in which the display panel 120 is accommodated. The upper receiving container 110 is coupled to the lower receiving container 115.

The mold frame 180 is disposed between the upper receiving container 110 and the lower receiving container 115 and accommodates the display panel 120 and the optical sheet 140 thereon. The optical sheet 140 is disposed on the light guide plate 150 and accommodated in the upper and lower receiving containers 110 and 115 to diffuse or collect the light exiting from the light guide plate 150. The optical sheet 140 may include a first prism sheet, a second prism sheet and a protection sheet. The first and second prism sheets refract the light exiting from the light guide plate 150 to allow the light to be collected in the front direction, such that brightness of the display apparatus 100 is substantially improved in an effective viewing angle. The protection sheet disposed on the first and second prism sheets protects the first and second prism sheets from external impacts and allows the light to be diffused and to be substantially uniformly distributed. However, the configuration of the optical sheets 140 is not limited to the above-mentioned configuration. In an alternative exemplary embodiment, the configuration of the optical sheets 140 may be variously changed or modified without being limited to a specific configuration.

The light guide plate 150 is disposed, e.g., accommodated, in the lower receiving container 115 to be adjacent to a plurality of light sources 174 and guides the light provided from the light sources 174. The light guide plate 174 diffuses the light emitted from the light sources 174 in various directions and effectively prevents bright lines from appearing on the display apparatus 100, which may occur by the arrangement of the light sources 174. The light guide plate 150 includes a light incident port to which the light from the light sources 174 is incident and a light opposite part opposite to the light incident part.

The reflection sheet 160 is disposed under the light guide plate 150 to reflect the light leaked downward from the light guide plate 150. The reflection sheet 160 reduces loss of the light and substantially improves uniformity of the light incident to the display panel 120. In an exemplary embodiment, the reflection sheet 160 may be prepared as a separate sheet. In an alternative exemplary embodiment, the reflection sheet 160 may be a reflection pattern formed by coating a material having a high reflectivity on the lower receiving container 115.

The backlight unit 170 is disposed in the lower receiving container 115 and includes a circuit substrate 172 and the light sources 174 disposed, e.g., mounted, on the circuit substrate 172. The light sources 174 may be a point light source such as a light emitting diode, for example, but not being limited thereto. The light sources 174 are arranged in one or more lines along a first direction X1 and spaced apart from each other. In an alternative exemplary embodiment, the light sources 174 may be a line light source. The circuit substrate 172, on which the light sources 174 are mounted, is disposed in the lower receiving container 115. FIG. 1 shows four light sources 174, but the number of the light sources 174 should not be limited to four.

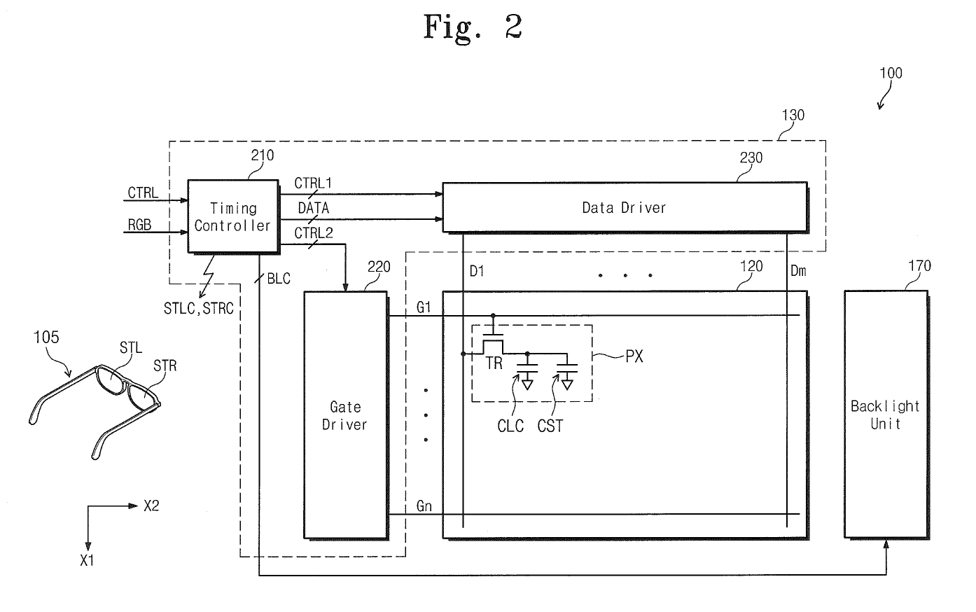

FIG. 2 is a block diagram showing an exemplary embodiment of the display apparatus including the display panel, the driving circuit and the backlight unit shown in FIG. 1.

Referring to FIG. 2, the display panel 120 displays the image. In an exemplary embodiment, as shown in FIG. 2, the display panel 120 is a liquid crystal display, but the display panel 120 should not be limited to the liquid crystal display.

The display panel 120 includes the data lines D1 to Dm extending in the first direction X1, the gate lines G1 to Gn extending in a second direction X2, and the pixels PX connected to the gate lines G1 to Gn and the data lines D1 to Dm. The data lines D1 to Dm are insulated from the gate lines G1 to Gn. Each pixel PX includes a thin film transistor TR, a liquid crystal capacitor CLC and a storage capacitor CST.

Each of the pixels PX has a same structure and function, and thus hereinafter, one pixel will be described in detail, for convenience of description. In one exemplary embodiment, for example, the thin film transistor TR of a pixel includes a gate electrode connected to a first gate line G1 of the gate lines G1 to Gn, a source electrode connected to a first data line D1 of the data lines D1 to Dm, and a drain electrode connected to the liquid crystal capacitor CLC and the storage capacitor CST. First terminals of the liquid crystal capacitor CLC and the storage capacitor CST are connected in parallel to the drain electrode of the thin film transistor TR. Second terminals of the liquid crystal capacitor CLC and the storage capacitor CST are connected to a common voltage.

The driving circuit 130 includes a timing controller 210, a gate driver 220 and a data driver 230. The gate driver 220 and the data driver 230 serve as an image display controller to allow the image to be displayed on the display panel 120.

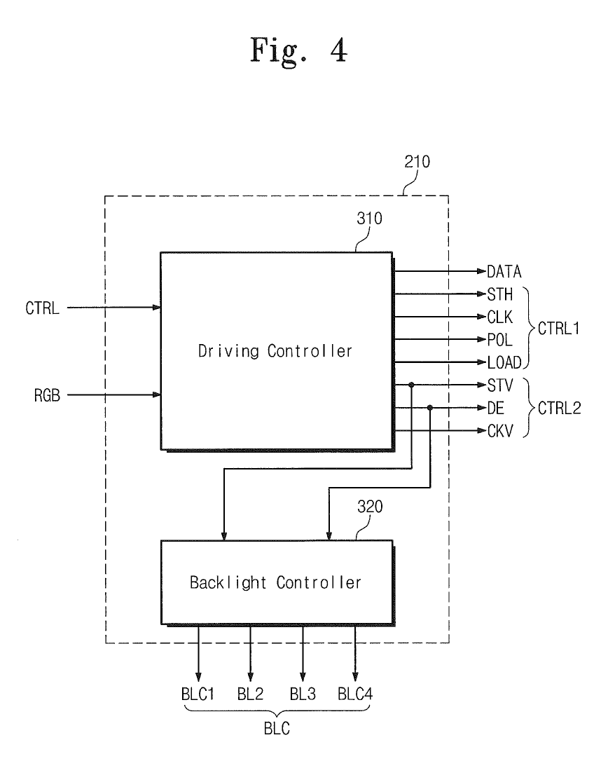

The timing controller 210 receives control signals CTRL and image signals RGB from an external source (not shown). The control signals CTRL includes a vertical synchronization signal, a horizontal synchronization signal, a main clock signal and a data enable signal, for example. The timing controller 210 converts the image signals RGB to image data signal DATA appropriate to the operation condition of the display panel 120 based on the control signals and applies the image data signal DATA and a first control signal CTRL1 to the data driver 230. The timing controller 210 applies a second control signal CTRL2 to the gate driver 220. The first control signal CTRL1 includes a horizontal synchronization start signal STH, a clock signal CLK, a polarity inversion signal POL and a line latch signal LOAD, and the second control signal CTRL2 includes a vertical synchronization start signal STV, an output enable signal DE and a gate pulse signal CKV (shown in FIG. 4). The timing controller 210 may output the image data signal DATA in various ways corresponding to an arrangement of the pixels PX of the display panel 120 and a display frequency.

The display apparatus 100 further includes shutter glasses 105. The timing controller 210 outputs a left-eye shutter control signal STLC and a right-eye shutter control signal STRC, which may be wireless signals, to control a left-eye shutter STL and a right-eye shutter STR, respectively.

In the shutter glasses 105 open or close the left-eye shutter STL in response to the left-eye shutter control signal STLC from the timing controller 210, and open or close the right-eye shutter STR in response to the right-eye shutter control signal STRC from the timing controller 210. The timing controller 210 may include a wireless transmitter to transmit the left-eye shutter control signal STLC and the right-eye shutter control signal STRC in wireless transmission, and the shutter glasses 105 may include a wireless receiver to receive the left-eye shutter control signal STLC and the right-eye shutter control signal STRC. When a left-eye image is displayed on the display panel 120, the left-eye shutter STL is opened and the right-eye shutter STR of the shutter glasses 105 is closed. When a right-eye image is displayed on the display panel 120, the left-eye shutter STL is closed and the right-eye shutter STR of the shutter glasses 105 is opened. Therefore, the viewer wearing the shutter glasses 105 may perceive the three-dimensional (“3D”) image.

The gate driver 220 drives the gate lines G1 to Gn in response to the second control signal CTRL2 from the timing controller 210. The gate driver 220 may include a gate driver integrated circuit. In an exemplary embodiment, the gate driver 220 may be realized by circuits using oxide semiconductor material, amorphous semiconductor material, crystalline semiconductor material or polycrystalline semiconductor material, for example. In an exemplary embodiment, the gate driver is mounted on the lower display substrate 122, as shown in FIG. 1. In an alternative exemplary embodiment, the gate driver 220 may be integrated on the lower display substrate 122.

The data driver 230 drives the data lines D1 to Dm in response to the image data signal DATA and the first control signal CTRL1.

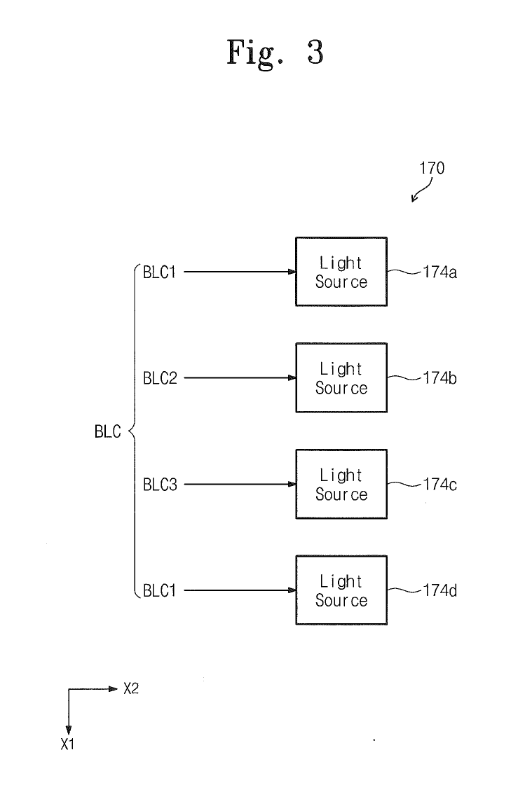

The timing controller 210 further outputs backlight control signals BLC to control the backlight unit 170 (shown in FIG. 3). The backlight unit 170 will be described in detail with reference to FIG. 3.

FIG. 3 is a block diagram showing an exemplary embodiment of the backlight unit shown in FIG. 2.

Referring to FIG. 3, the backlight unit 170 includes the light sources, e.g., a first light source 174a, a second light source 174b, a third light source 174c and a fourth light source 174d, and the backlight control signals BLC output from the timing controller 210 include backlight control signals, e.g., a first backlight control signal BLC1, a second backlight control signal BLC2, a third backlight control signal BLC3 and a fourth backlight control signal BLC4. Each of the light sources 174a, 174b, 174c and 174d is controlled by a corresponding backlight control signal among the backlight control signals BLC1, BLC2, BLC3 and BLC4, respectively. In one exemplary embodiment, for example, when the first backlight control signal BLC1 has a first level, e.g., a high level, the first light source 174a is turned on, and when the first backlight control signal BLC1 has a second level, e.g., a low level, the first light source 174a is turned off. When the second backlight control signal BLC2 has the first level, the second light source 174b is turned on, and when the second backlight control signal BLC2 has the second level, the second light source 174b is turned off. When the third backlight control signal BLC3 has the first level, the third light source 174c is turned on, and when the third backlight control signal BLC3 has the second level, the third light source 174c is turned off. When the fourth backlight control signal BLC4 has the first level, the fourth light source 174d is turned on, and when the fourth backlight control signal BLC4 has the second level, the fourth light source 174d is turned off.

In an exemplary embodiment, the light sources 174a, 174b, 174c and 174d are sequentially turned on and off in response to the backlight control signals BLC1, BLC2, BLC3 and BLC4. In such an embodiment, the second light source 174b is turned on after a predetermined time period lapses after the first light source 174a is turned on. In such an embodiment, the third light source 174c is turned on after a predetermined time period lapses after the second light source 174b is turned on. Similarly, the fourth light source 174d is turned on after a predetermined time period lapses after the third light source 174c is turned on. Thus, the light sources 174a, 174b, 174c and 174d may be sequentially turned on and off.

When the gate lines G1 to Gn of the display panel 120 are divided into first, second, third and fourth gate line groups along the first direction X1, the light sources 174a, 174b, 174c and 174d correspond to the first, second, third and fourth gate line groups, respectively. In one exemplary embodiment, for example, the first light source 174a corresponds to the first gate line group, the second light source 174b corresponds to the second gate line group, the third light source 174c corresponds to the third gate line group, and the fourth light source 174d corresponds to the fourth gate line group.

In an exemplary embodiment, as shown in FIG. 3, the number of the light sources included in the backlight unit 170 may be four, and the number of the backlight control signals BLC output from the timing controller 210 is four. When the number of the light sources included in the backlight unit 170 is ‘L’ (here, ‘L’ is a natural number), the number of the backlight control signals BLC output from the timing controller 210 is ‘L’. In an alternative exemplary embodiment, one backlight control signal may control a plurality of light sources, and the number of the backlight control signals BLC may be less than ‘L’.

FIG. 4 is a block diagram showing an exemplary embodiment of the timing controller shown in FIG. 2.

Referring to FIG. 4, the timing controller 210 includes a driving controller 310 and a backlight controller 320. The driving controller 310 receives the control signals CTRL and the image signals RGB from the external source. The timing controller 210 outputs the image data signals DATA and the first control signal CTRL1 including the horizontal synchronization start signal STH, the clock signal CLK, the polarity inversion signal POL and the line latch signal LOAD. In such an embodiment, the timing controller 210 outputs the second control signal CTRL2 including the vertical synchronization start signal STV, the output enable signal DE and the gate pulse signal CKV.

The vertical synchronization start signal STV and the output enable signal DE included in the second control signal CTRL2 output from the timing controller 210 are applied to the backlight controller 320. The backlight controller 320 generates the control signals BLC1, BLC2, BLC3 and BLC4 in response to the vertical synchronization start signal STV and the output enable signal DE. The backlight controller 320 generates the control signals BLC1, BLC2, BLC3 and BLC4 to allow the light sources 174a, 174b, 174c and 174d to be periodically turned on and off. In an exemplary embodiment, the backlight controller 320 generates the control signals BLC1, BLC2, BLC3 and BLC4 such that the light sources 174a, 174b, 174c and 174d are turned on during different time periods according to the positions of the light sources 174a, 174b, 174c and 174d arranged in the first direction X1.

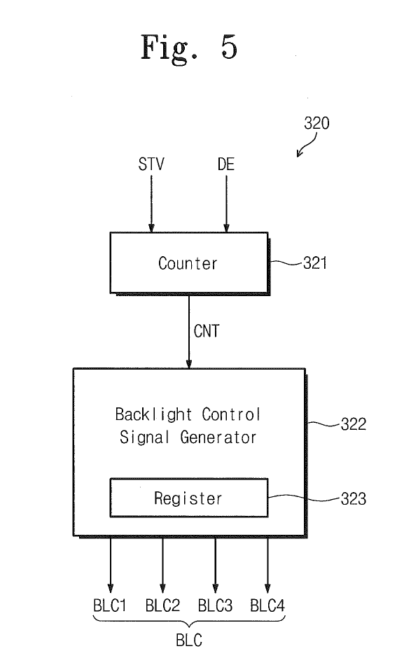

FIG. 5 is a block diagram showing an exemplary embodiment of the backlight controller shown in FIG. 4.

Referring to FIG. 5, the backlight controller 320 includes a counter 321 and a backlight control signal generator 322. The counter 321 resets a count signal CNT in synchronization with the vertical synchronization start signal STV and counts up the count signal CNT in synchronization with the output enable signal DE. In one exemplary embodiment, for example, where the display panel 120 has a resolution of 1920×1080 for full high definition (“FHD”), the count signal CNT has a maximum value of 1080+α (α indicates the number of horizontal lines in a blank period).

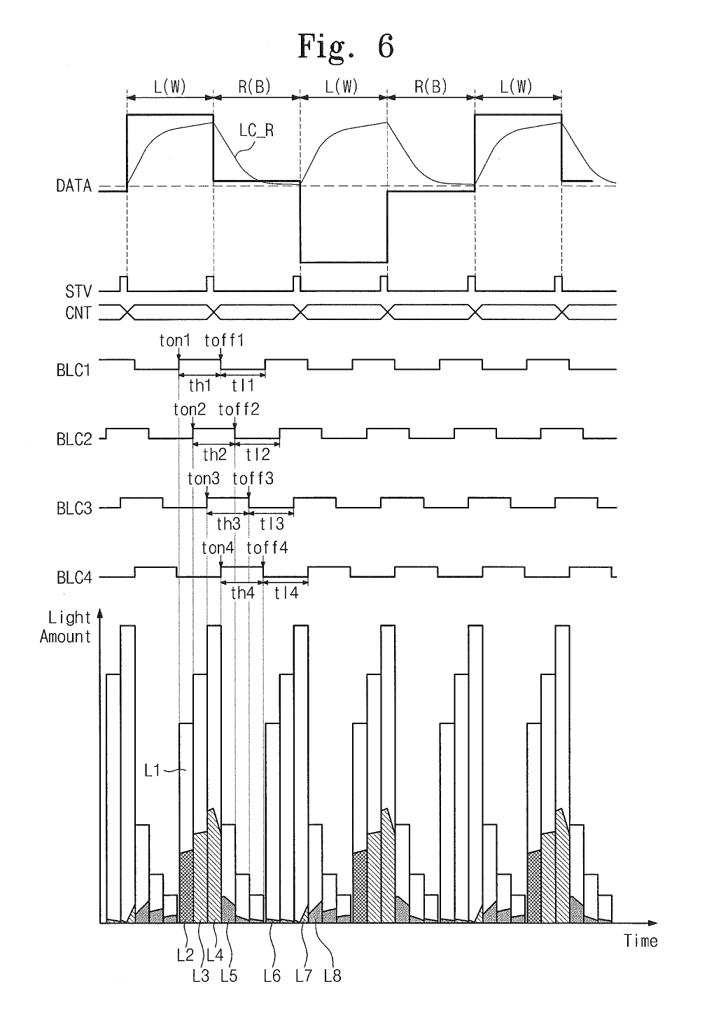

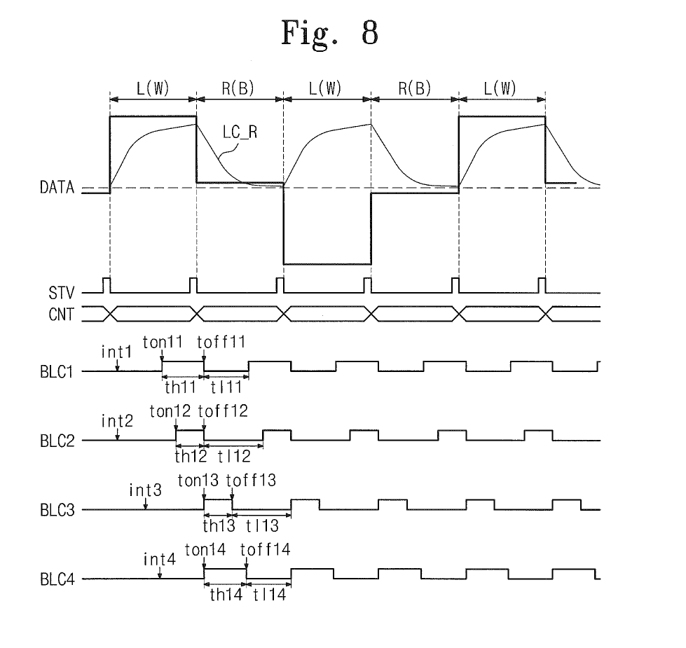

The backlight control signal generator 322 generates the control signals BLC1, BLC2, BLC3 and BLC4 in response to the count signal CNT from the counter 321. The backlight control signal generator 322 includes a register 323. The register 323 stores first count signals ton1, ton2, ton3 and ton4, which are corresponding to the turn-on timings, e.g., the turn-on time points, of the light sources 174a, 174b, 174c and 174d, respectively, and second count signals toff1, toff2, toff3 and toff4, which are corresponding to the turn-off timings, e.g., the turn-off time points, of the light sources 174a, 174b, 174c and 174d, respectively (shown in FIGS. 6 to 8). The register 323 may further store a plurality of third count signals corresponding to initialization time points int1, int2, int3 and int4 of the light sources 174a, 174b, 174c and 174d (shown in FIG. 8).

In an exemplary embodiment, the backlight control signal generator 322 transits a corresponding backlight control signal of the backlight control signals BLC1, BLC2, BLC3, and BLC4 to the first level, e.g., the high level, whenever the count signal CNT from the counter 321 reaches each of the first count signals ton1, ton2, ton3 and ton4. In such an embodiment, the backlight control signal generator 322 transits the corresponding backlight control signal of the backlight control signals BLC1, BLC2, BLC3 and BLC4 to the second level, e.g., the low level, whenever the count signal CNT from the counter 321 reaches each of the second count signals toff1, toff2, toff3, and toff4. In such an embodiment, the first count signals ton1, ton2, ton3 and ton4 and the second count signals toff1, toff2, toff3 and toff4, which are stored in the register 323, are set based on the positions of the light sources 174a, 174b, 174c and 174d arranged in the first direction X1.

In one exemplary embodiment, for example, the first count signals ton1, ton2, ton3 and ton4 and the second count signals toff1, toff2, toff3 and toff4 are set such that the light sources, e.g., the second and third light sources 174b and 174c, which are located at positions closer to a center portion in the first direction X1 of the display panel 120, are turned on during a turn-on time period shorter than a turn-on time period in which the light sources, e.g., the first and fourth light sources 174a and 174d, which are respectively located at side portions, e.g., upper and lower portions, in the first direction X1 of the display panel 120, are turned on.

FIG. 6 is a signal timing diagram showing an operation of the display apparatus shown in FIGS. 1 to 5.

Referring to FIGS. 5 and 6, each of the first count signals ton1, ton2, ton3 and ton4 indicates the time period from a time point at which the vertical synchronization start signal STV is transited from the first level, e.g., the high level, to the second level, e.g., the low level, to a time point at which the corresponding backlight control signal of the backlight control signals BLC1, BLC2, BLC3 and BLC4 is transited from the low level to the high level. Each of the second count signals toff1, toff2, toff3 and toff4 indicates the time period from a time point at which the vertical synchronization start signal STV is transited from the first level to the second level to a time point at which the corresponding backlight control signal of the backlight control signals BLC1, BLC2, BLC3 and BLC4 is transited from the high level to the low level.

In an exemplary embodiment, the first count signals ton1, ton2, ton3 and ton4 stored in the register 323 have a predetermined time period, and the second count signals toff1, toff2, toff3 and toff4 stored in the register 323 have the predetermined time period. In such an embodiment, each of the backlight control signals BLC1, BLC2, BLC3 and BLC4 output from the backlight control signal generator 322 has a same high level maintain time th1, th2, th3 and th4 and a same low level maintain time tl1, tl2, tl3 and tl4.

FIG. 6 shows variations of optical properties with the amount of the light of an upper portion of the light opposite part of the light guide plate 150, which is relatively distant from the backlight unit in the upper surface of the display panel shown in FIG. 2. In one exemplary embodiment, for example, as shown in FIG. 2, where the backlight unit 170 is disposed at a right side position of the display panel 120, the right side portion and the left side portion of the display panel 120 serve as the light incident part and the light opposite part, respectively. The variation of the light amount shown in FIG. 6 is measured in the measuring area adjacent to the gate line G1 and the data line D1 of the display panel 120 shown in FIG. 2.

Referring to FIG. 6, a light amount L1 is measured in the measuring area of the display panel 120 in accordance with the turn-on and off of the light sources 174a, 174b, 174c and 174d. When the light sources 174a, 174b, 174c and 174d are sequentially turned on in response to the backlight control signals BLC1, BLC2, BLC3 and BLC4, the light amount L1 in the measuring area of the display panel 120 is gradually increased. When the light source 174a corresponding to the measuring area is turned off in response to the backlight control signal BLC1, the light amount L1 in the measuring area of the display panel 120 is thereby reduced.

In FIG. 6, first to seventh light amounts L2 to L8 are measured in the measuring area of the display panel 120, sequentially corresponding to the turn-on and off of the light sources 174a, 174b, 174c and 174d of the backlight unit 170 and the response LC_R of the liquid crystals to the image data signal DATA. That is, as shown in FIG. 6, the first light amount L2 corresponds to a period between a rising edge of the first backlight control signal BLC1 and a rising edge of the second backlight control signal BLC2, the second light amount L3 corresponds to a period between the rising edge of the second backlight control signal BLC2 and a rising edge of the third control signal BLC3, the third light amount L4 corresponds to the rising edge of the third backlight control signal BLC3 and a rising edge of the fourth backlight control signal BLC4, and the fourth light amount L4 corresponds to the rising edge of the fourth backlight control signal BLC4 and a falling edge of the second backlight control signal BLC2.

When the image data signal DATA having a high gray scale level, e.g., a white gray scale level W, is provided to the display panel 120 during a left-eye period L and the image data signal DATA having a low gray scale level, e.g., a black gray scale level B, is provided to the display panel 120 during a right-eye period R, the second light amount L3 is greater than the first light amount L2, as the second light amount L3 measured in the measuring area of the display panel 120 is increased by the light diffused when the first and second light sources 174a and 174b are turned on even though the image data signal DATA having the same white gray scale level W is provided to the display panel 120 during the left-eye period L. Similarly, when the light sources 174a, 174b, 174c and 174d are turned on, the third light amount L4 is greater than the first and second light amounts L2 and L3.

In FIG. 6, due to the delay of the liquid crystal response LC_R, the fourth and fifth light amounts L5 and L6 are measured during the right-eye period R in which the image data signal DATA having the black gray scale level B is provided to the display panel 120. When the gray scale level of the image data signal DATA is changed from the black gray scale level B to the white gray scale level W, the light is measured in the measuring area of the display panel 120 before the backlight control signal BLC1 of a next frame is transited to the high level such that the black gray scale level B of the right-eye period R may not be maintained for one frame. As shown in FIG. 6, however, the sixth and seventh light amounts L7 and L8 are measured by the diffusion of the light from the first to third light sources 174a, 174b and 174c.

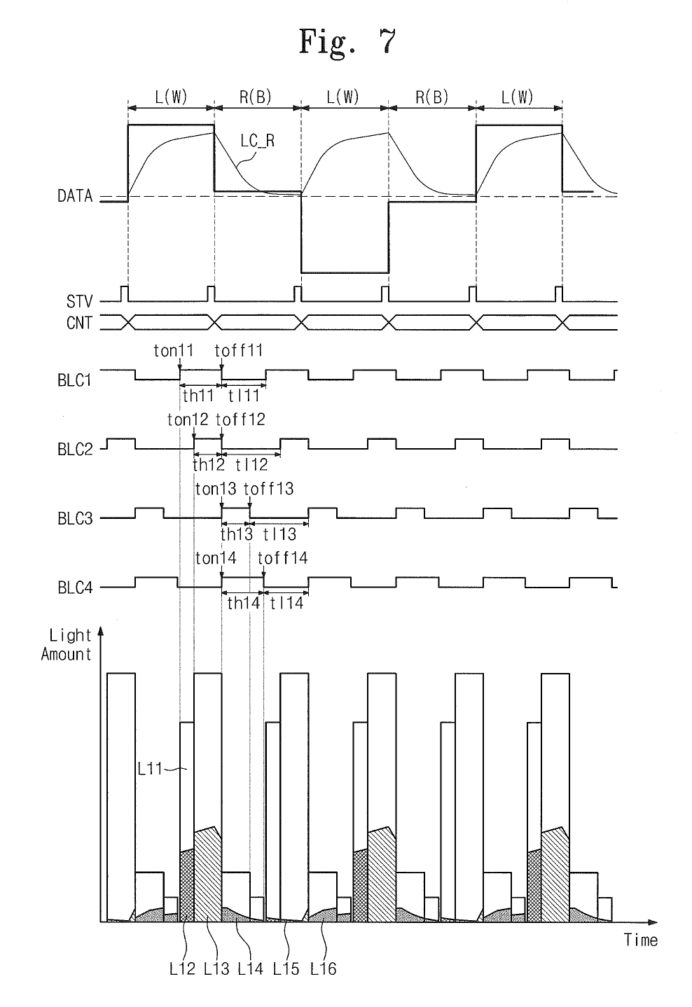

FIG. 7 is a signal timing diagram showing another operation of the display apparatus shown in FIGS. 1 to 5.

Referring to FIG. 7, in an exemplary embodiment, first count signals ton11, ton12, ton13 and ton14 stored in the register 323 have different time periods, and second count signals toff11, toff12, toff13 and toff14 stored in the register 323 have the different time periods. In such an embodiment, the backlight control signals BLC1, BLC2, BLC3 and BLC4 output from the backlight control signal generator 322 have different high level maintain times th11, th12, th13 and th14 and different low level maintain times tl1, tl12, tl13 and tl14.

In such an embodiment, the turn-on time periods th12 and th13 of the second and third light sources 174b and 174c disposed closer to the center portion in the first direction X1 of the display panel 120 are shorter than the turn-on time periods th11 and th14 of the first and fourth light sources 174a and 174d disposed at the side portions, e.g., upper and lower portions, respectively, in the first direction X1 of the display panel 120. In such an embodiment, the turn-off time periods tl12 and tl13 of the second and third light sources 174b and 174c disposed closer to the center portion in the first direction X1 of the display panel 120 are longer than the turn-off time periods tl11 and tl14 of the first and fourth light sources 174a and 174d disposed at the side portions, e.g., the upper and lower portions, respectively, in the first direction X1 of the display panel 120. In an exemplary embodiment, the crosstalk may occur in the areas of the display panel 120 corresponding to side portions, e.g., the upper and lower portions, of the light opposite part by the diffusion of the light from the light sources 174b and 174c disposed closer to the center portion in the first direction X1 of the display panel 120. In such an embodiment, when the turn-on time periods th12 and th13 of the second and third light sources 174b and 174c, which are disposed in the middle portion, are shortened, the crosstalk in the areas of the display panel 120 corresponding to the side portions of the light opposite pate is effectively prevented, and the display quality in the side portions, e.g., the upper and lower portions, of the display panel 120 is thereby substantially improved.

Referring again to FIG. 7, a light amount L11 is measured in the measuring area of the display panel 120 in accordance with the turn-on and off of the light sources 174a, 174b, 174c and 174d of the backlight unit 170. When the light sources 174a and 174b are sequentially turned on in response to the backlight control signals BLC1 and BLC2, the light amount L11 in the measuring area of the display panel 120 is gradually increased. When the light source 174a corresponding to the measuring area is turned off in response to the backlight control signal BLC1, the light amount L11 in the measuring area of the display panel 120 is substantially reduced.

In FIG. 7, first to fifth light amounts L12 to L16 are measured in the measuring area of the display panel 120 sequentially corresponding to the turn-on and off of the light sources 174a, 174b, 174c and 174d of the backlight unit 170 and the liquid crystal response LC_R of to the image data signal DATA.

As shown in FIGS. 6 and 7, when the white gray scale level W is displayed, the third light amount L14 shown in FIG. 7 is reduced compared to the third light amount L4 shown in FIG. 6. When the black gray scale level B is displayed, the fourth light amounts L15 and L16 shown in FIG. 7 are reduced compared to the fourth, fifth and sixth light amounts L5, L6 and L7 shown in FIG. 6. In such an embodiment, the crosstalk due to the white image of the previous frame that exerts influence on the black image of the next frame is effectively prevented.

FIG. 8 is a signal timing diagram showing an operation of the display apparatus shown in FIGS. 1 to 5 when the display apparatus is reset.

Referring to FIG. 8, when the display apparatus 100 is reset, the timing controller 210 generates and applies the vertical synchronization start signal STV and the output enable signal DE to the counter 321. The counter 321 starts counting in response to the vertical synchronization start signal STV, and performs the count-up operation in synchronization with the output enable signal DE.

In an exemplary embodiment, the second count signals toff1, toff2, toff3 and toff4 are closer to the vertical synchronization start signal STV than the first count signals ton1, ton2, ton3, and ton4, and when the count signal CNT from the counter 321 is applied to the backlight control signal generator 322, the backlight control signal generator 322 generates the backlight control signals BLC1, BLC2, BLC3 and BLC4 after the initialization time points int1, int2, int3 and int4 lapse, respectively. In such an embodiment, the backlight control signal generator 322 transits the backlight control signals BLC1, BLC2, BLC3 and BLC4 to the first level, e.g., the high level, when the count signal CNT from the counter reaches each of sums of the first and third count signals, when the display apparatus is reset. In one exemplary embodiment, for example, when the count signal CNT reaches the first count signal ton11 after the initialization time point int1 lapses after the vertical synchronization start signal STV is transited from the high level to the low level, the backlight control signal BLC1 is transited to the high level by the backlight control signal generator 322. Then, when the count signal CNT reaches the second count signal toff11 after the vertical synchronization start signal STV is transited from the high level to the low level again, the backlight control signal BLC1 is transited to the low level, and when the count signal CNT reaches the first count signal ton11 again, the backlight control signal BLC1 is transited to the high level. As described above, the backlight control signal generator 322 may controls the backlight control signals BLC1, BLC2, BLC3 and BLC4.

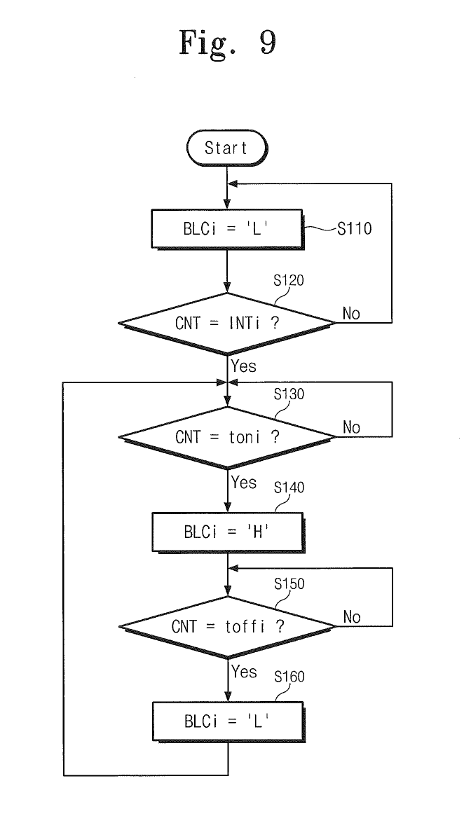

FIG. 9 is a flowchart showing an exemplary embodiment of an operation of the backlight control signal generator shown in FIG. 5. Referring to FIGS. 5, 8 and 9, when the count signal CNT from the counter 321 starts inputting to the backlight control signal generator 322, the backlight control signal generator 322 sets the backlight control signals BLCi to the low level L (S110). In an exemplary embodiment, the ‘i’ is a natural number equal to or less than ‘K’, and ‘K’ is the number of the light sources 174a, 174b, 174c and 174d. In one exemplary embodiment, for example, ‘K’ is four as shown in FIG. 3.

When the count signal CNT reaches the initialization time point INTi stored in the register 323 (S120), the backlight control signal generator 322 processes operation (S130). When the count signal CNT does not reach the initialization time period INTi stored in the register 323 (S120), the backlight control signal generator 322 maintains the backlight control signals BLCi at the low level L.

Then, when the count signal CNT reaches the first count signal toni stored in the register 323 after the count signal CNT reaches the initialization time point INTi stored in the register 323 (S130), the backlight control signal generator 322 transits the backlight control signal BLCi corresponding to the first count signal toni to the high level H (S140).

When the count signal CNT reaches the second count signal toffi stored in the register 323 (S150), the backlight control signal generator 322 transits the backlight control signal BLCi corresponding to the second count signal toffi to the low level L (S160). In such an embodiment, the backlight control signal generator 322 performs the steps S130 to S160 to sequentially turn on and off the backlight control signal BLC1, BLC2, BLC3 and BLC4.

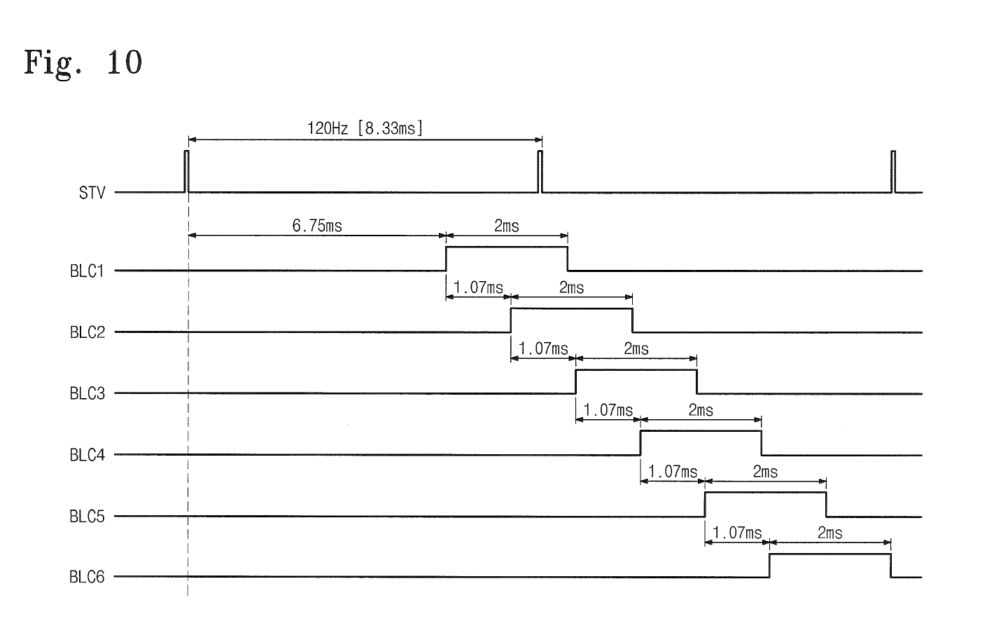

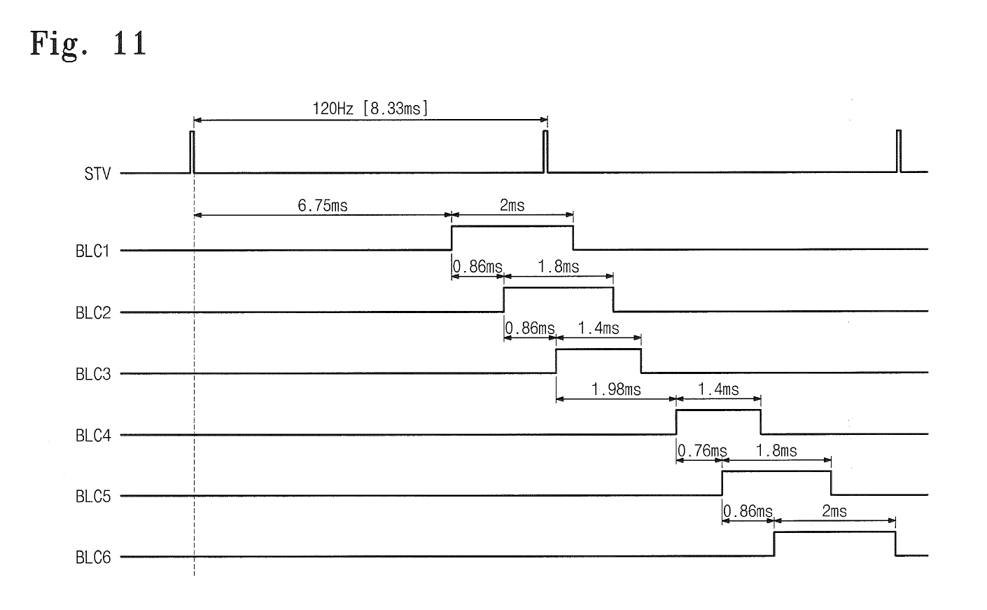

FIGS. 10 and 11 are signal timing diagrams showing backlight control signals when the number of the light sources included in the backlight unit is six.

Referring to FIG. 10, the first count signals stored in the register 323 shown in FIG. 5 have the same value, and the second count signals stored in the register 323 shown in FIG. 5 have the same value. In one exemplary embodiment, for example, the backlight control signals BLC1 to BLC6 are sequentially activated to the high level with a time difference of about 1.07 millisecond (ms), and each of the backlight control signals BLC1 to BLC6 has the same high level period of about 2 ms.

Referring now to FIG. 11, the first and second count signals stored in the register shown in FIG. 5 may be set to have predetermined values based on the positions of six light sources. In FIG. 11, each of the backlight control signals BLC3 and BLC4 used to control the light sources disposed closer to the center portion of the display panel may have the high level period of about 1.4 ms, and each of the backlight control signals BLC1 and BLC6 used to control the light sources disposed closer to the side portions, e.g., the upper and lower portions, of the display panel may have the high level period of about 2 ms. As described above, the high level period of the backlight control signals BLC3 and BLC4 used to control the light sources disposed closer to the center portion of the display panel is set shorter than the high level period of the backlight control signals BLC1 and BLC6 used to control the light sources disposed closer to the side portions, e.g., the upper and lower portions, of the display panel, and the crosstalk due to the image of the previous frame exerts that influence on the image of the next frame is thereby effectively prevented.

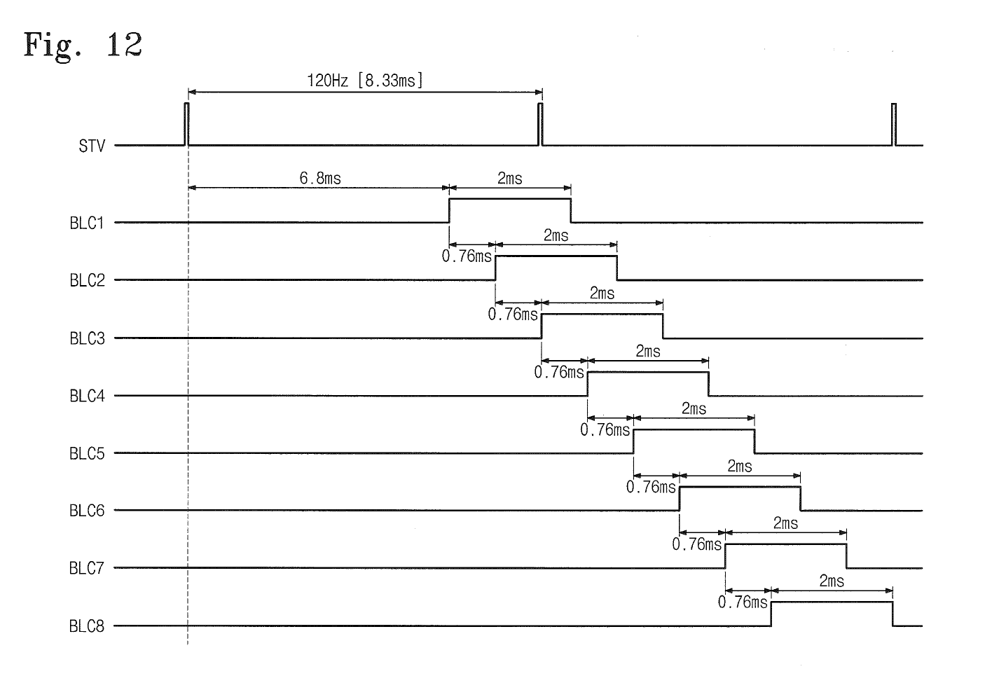

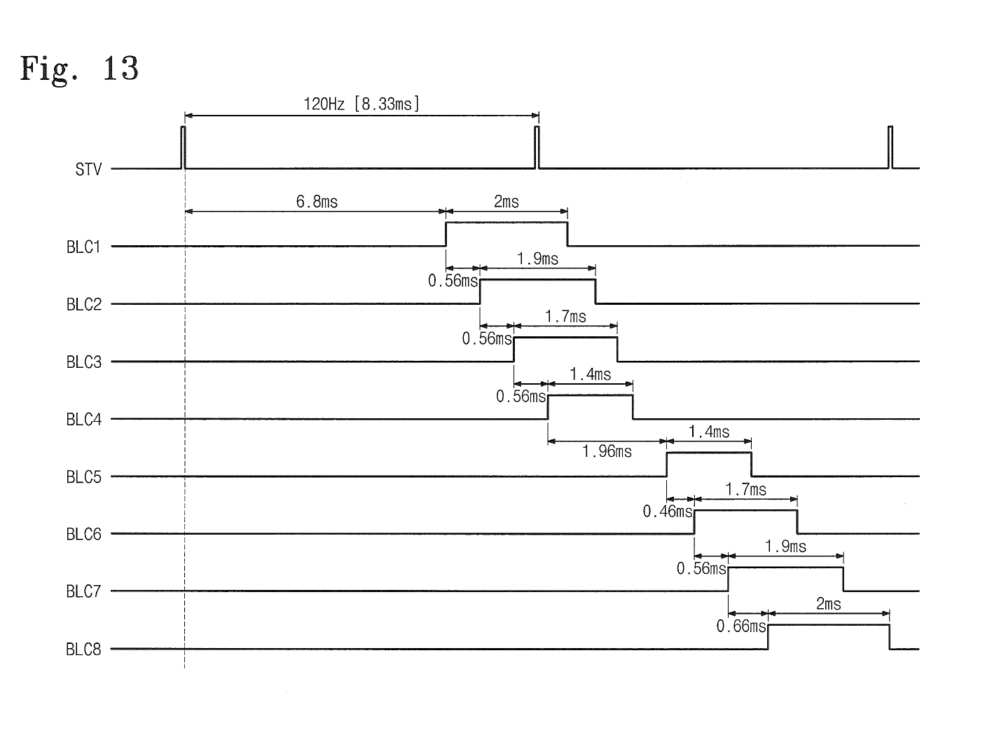

FIGS. 12 and 13 are signal timing diagrams showing backlight control signals when the number of the light sources included in the backlight unit is eight.

Referring to FIG. 12, when the first count signals stored in the register 323 shown in FIG. 5 have the same value and the second count signals stored in the register 323 shown in FIG. 5 have the same value, the backlight control signals BLC1 to BLC6 may be sequentially activated to the high level with a time difference of about 0.76 ms, and each of the backlight control signals BLC1 to BLC6 has the same high level period of about 2 ms.

Referring to FIG. 13, the first and second count signals stored in the register shown in FIG. 5 may be set to have optimized values according to the positions of eight light sources. In FIG. 13, each of the backlight control signals BLC4 and BLC5 used to control the light sources disposed closer to the center portion of the display panel may have the high level period of about 1.4 ms, and each of the backlight control signals BLC1 and BLC8 used to control the light sources disposed closer to the side portions, e.g., the upper and lower portions, of the display panel may have the high level period of about 2 ms. As described above, the high level period of the backlight control signals BLC4 and BLC5 used to control the light sources disposed closer to the center portion of the display panel is set shorter than the high level period of the backlight control signals BLC1 and BLC8 used to control the light sources disposed closer to the side portions, e.g., the upper and lower portions, of the display panel, and the crosstalk due to the image of the previous frame that exerts influence on the image of the next frame is thereby effectively prevented.

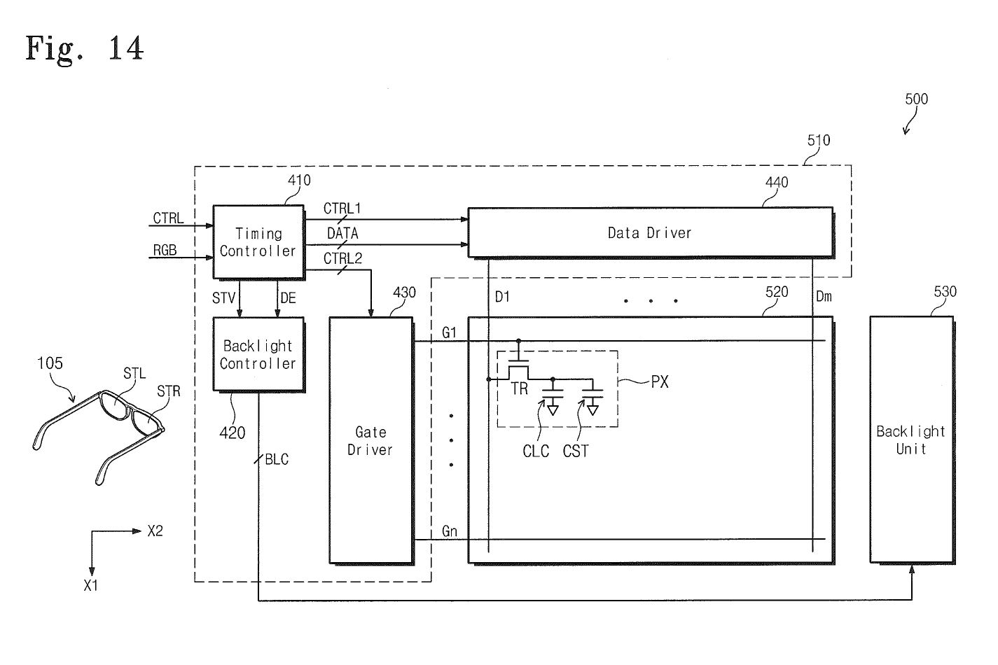

FIG. 14 is a block diagram showing an alternative exemplary embodiment of a display apparatus according to the invention.

Referring to FIG. 14, a driving circuit 510 in a display apparatus 500 includes a backlight controller 420, which is disposed outside the timing controller 410. The backlight controller 420 generates backlight control signals BLC in response to the vertical synchronization start signal STV and the output enable signal DE from the timing controller 410.

Gate and data drivers 430 and 440 in the driving circuit 510, a display panel 520 and a backlight unit 530 of FIG. 14 have substantially the same configuration and function as the gate and data drivers 220 and 230 of the display panel 120 and the backlight unit 170 shown in FIG. 2, and any repetitive detailed descriptions thereof will be omitted.

In such an embodiment, when the backlight controller 420 is individually configured from the timing controller 410, the circuit configuration of the timing controller 410 may be simplified.

Although the exemplary embodiments of the invention have been described, it is understood that the invention should not be limited to these exemplary embodiments but various changes and modifications can be made by one ordinary skilled in the art within the spirit and scope of the invention as hereinafter claimed.

What is claimed is:

1. A display apparatus comprising:
a display panel which includes a plurality of pixels;
a backlight unit which includes a plurality of light sources sequentially arranged in a first direction of the display panel, and provides light to the display panel; and
a driving circuit which controls the display panel to allow an image to be displayed on the display panel and generates a plurality of backlight control signals to periodically turn on and turn off the light sources,
wherein the driving circuit generates the backlight control signals to allow the light sources to have different turn-on time periods based on positions of the light sources.

2. The display apparatus of claim 1, wherein a turn-on time period of the light sources disposed closer to a center portion in the first direction of the display panel is shorter than a turn-on time period of the light sources disposed at a side portion in the first direction of the display panel.

3. The display apparatus of claim 1, wherein
the pixels are connected to a plurality of gate lines and a plurality of data lines crossing the gate lines, and the driving circuit comprises:
a data driver which drives the data lines;
a gate driver which drives the gate lines; and
a timing controller which controls the data driver and the gate driver in response to an image signal and a control signal from an external source, and generates the backlight control signals.

4. The display apparatus of claim 3, wherein the timing controller comprises:
a driving controller which controls the data driver and the gate driver in response to the image signal and the control signal; and
a backlight controller which generates the backlight control signals.

5. The display apparatus of claim 4, wherein the driving controller applies a vertical synchronization start signal and an output enable signal, which are generated from the timing controller based on the control signal, to the gate driver.

6. The display apparatus of claim 5, wherein the backlight controller generates the backlight control signals in response to the vertical synchronization start signal and the output enable signal.

7. The display apparatus of claim 6, wherein the backlight controller comprises:
a counter which outputs a count signal in response to the vertical synchronization start signal and the output enable signal; and
a backlight control signal generator which outputs the backlight control signals in response to the count signal from the counter.

8. The display apparatus of claim 7, wherein the counter starts counting in response to the vertical synchronization start signal and increases the count signal in synchronization with the output enable signal.

9. The display apparatus of claim 8, wherein the backlight control signal generator comprises a register which stores a plurality of first count signals respectively corresponding to turn-on time points of the light sources and a plurality of second count signals respectively corresponding to turn-off time points of the light sources.

10. The display apparatus of claim 9, wherein
the backlight control signal generator transits a corresponding backlight control signal of the backlight control signals to a first level when the count signal from the counter reaches each of the first count signals, and
the backlight control signal generator transits the corresponding backlight control signal of the backlight control signals to a second level when the count signal from the counter reaches each of the second count signals.

11. The display apparatus of claim 9, wherein
the register further stores a plurality of third count signals, each corresponding to an initialization time point of a corresponding light source of the light sources, and
the backlight control signal generator transits the backlight control signals to the first level when the count signal from the counter reaches a sum of corresponding first count signal and third count signal among the first count signals and the third count signals while the display apparatus is reset.

12. The display apparatus of claim 1, wherein
the pixels are connected to a plurality of gate lines and a plurality of data lines crossing the gate lines, and the driving circuit comprises:
a data driver which drives the data lines;
a gate driver which drives the gate lines;
a timing controller which controls the data driver in response to an image signal and a control signal from an external source and applies the backlight control signals to the gate driver; and
a backlight controller which generates the backlight control signals.

13. The display apparatus of claim 12, wherein the backlight controller comprises:
a counter which outputs a count signal in response to a vertical synchronization start signal and an output enable signal, which are generated from the timing controller based on the control signal; and
a backlight control signal generator which outputs the backlight control signals in response to the count signal from the counter.

14. The display apparatus of claim 13, wherein
the counter starts counting in response to the vertical synchronization start signal and increases the count signal in synchronization with the output enable signal, and
the backlight control signal generator comprising a register which stores a plurality of first count signals respectively corresponding to turn-on time points of the light sources and a plurality of second count signals respectively corresponding to turn-off time points of the light sources.

15. The display apparatus of claim 14, wherein
the backlight control signal generator transits a corresponding backlight control signal of the backlight control signals to a first level when the count signal from the counter reaches each of the first count signals, and
the backlight control signal generator transits the corresponding backlight control signal of the backlight control signals to a second level when the count signal from the counter reaches each of the second count signals.

16. A method of driving a display apparatus, the method comprising:
counting a second signal in response to a first signal to output a count signal;
transiting a corresponding backlight control signal to a first level when the count signal reaches each of a plurality of first count signals respectively corresponding to turn-on time points of a plurality of light sources of the display apparatus; and
transiting the corresponding backlight control signal to a second level when the count signal reaches each of a plurality of second count signals respectively corresponding to turn-off time points of the light sources,
wherein
the light sources are sequentially arranged in a first direction of a display panel of the display apparatus, and
the first count signals and second count signals are set based on positions of the light sources arranged in the first direction.

17. The method of claim 16, wherein the first count signals and second count signals are set to allow a turn-on time period of the light sources disposed closer to a center portion in the first direction of the display panel to be shorter than a turn-on time period of the light sources disposed at a side portion in the first direction of the display panel.

18. The method of claim 16, wherein
the first signal is a vertical synchronization start signal, and
the second signal is an output enable signal.
